(19) United States
(12) Patent Application Publication
(10) Pub. No.: US 2016/0251550 A1
(43) Pub. Date: Sep. 1, 2016

(54) AQUEOUS ADHESIVE COMPOSITION WITH A BASE OF BIOSOURCED ALDEHYDE AND POLYPHENOL

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: CLEMENT MICHOUD, Clermont-Ferrand (FR); DAVID DOISNEAU, Clermont-Ferrand (FR)

(21) Appl. No.: 14/903,781

(22) PCT Filed: Jul. 11, 2014
(86) PCT No.: PCT/EP2014/064931

§ 371 Date: Jan. 8, 2016

(30) Foreign Application Priority Data
Jul. 16, 2013 (FR) 1356978

(51) Int. Cl. C09J 107/02; B32B 7/12; B32B 25/10; B32B 25/16; C09J 115/00; C08J 5/12

(52) U.S. Cl. CPC C09J 107/02; C09J 115/00; C08J 5/127; B32B 25/10; B32B 25/16; B32B 7/12; C08J 2319/00; C08J 2377/00; C08J 2367/02; B32B 2250/02; B32B 2255/02; B32B 2255/26; B32B 2605/00

(57) ABSTRACT

The aqueous adhesive composition comprises an unsaturated elastomer latex and a phenol/aldehyde resin based on an aldehyde of formula (I):

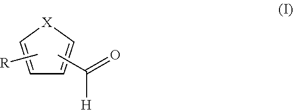

in which X comprises N, S or O and R represents —CHO, and based on a polyphenol comprising one or more aromatic nucleus/nuclei. When there is just one aromatic nucleus, the latter bears two or three hydroxyl functional groups in the meta position with respect to each other, the remainder of the aromatic nucleus being unsubstituted. When there are several aromatic nuclei, at least two of them each bear two or three hydroxyl functional groups in the meta position with respect to each other, the two positions ortho to at least one of these hydroxyl functional groups being unsubstituted.

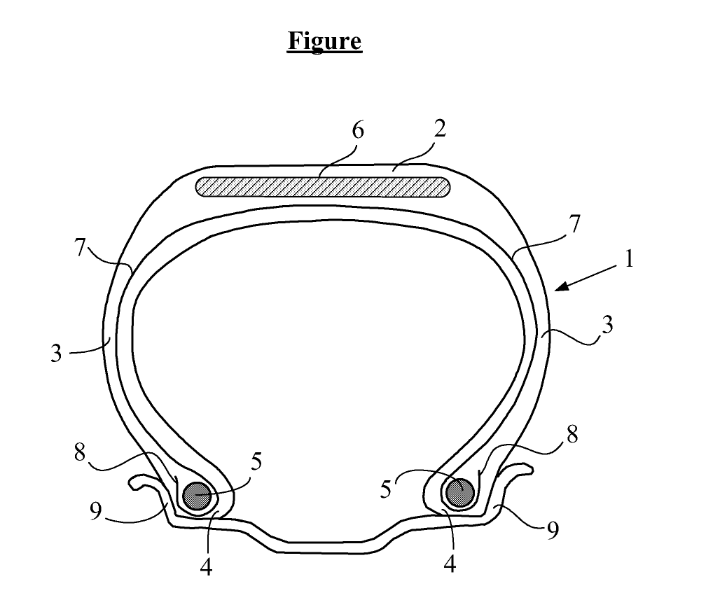

The field of the present invention is that of textile materials and adhesive compositions or “adhesives” intended to make such textile materials adhere to unsaturated rubber matrices, such as those commonly used in rubber articles or semi-finished products.

The present invention relates more particularly to textile materials sized with adhesive layers based on a phenol/aldehyde resin, in particular to sized textile materials capable of reinforcing tyre structures.

It has been known for a very long time to make textile materials adhere to diene elastomer compositions by virtue of the use of adhesives known under the name “RFL” (for resorcinol/formaldehyde latex), for example for the adhesive bonding of rubber compositions to textile cords made of polyester or polyamide, such as those normally used in tyres (see, for example, U.S. Pat. No. 2,561,215 and U.S. Pat. No. 3,817,778). These RFL adhesives comprise, in a well-known way, a thermosetting phenolic resin, obtained by the condensation of resorcinol with formaldehyde, and one or more latexes of diene rubber in aqueous solution.

Experience shows that the above RFL adhesives confer excellent adhesion of textile materials to crosslinkable rubber compositions.

However, these RFL adhesives are not without disadvantages; in particular they comprise formaldehyde as base substance, which substance it is desirable in the long run to reduce in, indeed even to eliminate from, adhesive compositions because of the recent changes in European regulations regarding this type of compound. In addition, formaldehyde is a compound derived from oil, from which it is desired as much as possible to be freed for reasons of increased scarcity.

Thus, the designers of rubber articles, in particular tyre manufacturers, today have the objective of finding novel adhesive systems or novel textile materials which make it possible to overcome the abovementioned disadvantages.

In point of fact, during their research studies, the Applicant Companies have discovered an aqueous adhesive composition not using formaldehyde which makes it possible to meet the above objective.

Thus, a first subject-matter of the invention relates to an aqueous adhesive composition comprising at least, on the one hand, A) a phenol/aldehyde resin and, on the other hand, B) an unsaturated elastomer latex, in which the phenol/aldehyde resin is based on at least:
A1) one aldehyde of formula (I):

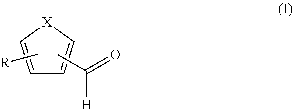

in which:
X comprises N, S or O
R represents —CHO
A2) one polyphenol comprising one or more aromatic nucleus/nuclei, it being understood that:
   in the case of just one aromatic nucleus, the latter bears two or three hydroxyl functional groups in the meta position with respect to each other or with respect to one another, the remainder of the aromatic nucleus being unsubstituted;
   in the case of several aromatic nuclei, at least two of them each bear two or three hydroxyl functional groups in the meta position with respect to each other or with respect to one another, it being understood that the two positions ortho to at least one of these hydroxyl functional groups are unsubstituted.

Another subject-matter of the invention relates to the use of the aqueous adhesive composition according to the invention to make a textile material adhere, by curing, to a crosslinkable rubber composition, and also to a textile material, at least a portion of which is coated with an adhesive layer, the said layer comprising an aqueous adhesive composition according to the invention.

The invention also relates to a process for the manufacture of a textile material comprising at least one stage of deposition, on a textile material, of an adhesive composition in accordance with the invention.

The invention also relates to the use of the textile material of the invention as reinforcing element for rubber articles or semi-finished products, in particular tyres, especially those intended to equip motor vehicles of passenger type, SUVs (“Sport Utility Vehicles”), two-wheel vehicles (in particular bicycles and motorcycles), aircraft, as for industrial vehicles chosen from vans, heavy-duty vehicles, that is to say, underground trains, buses, heavy road transport vehicles (lorries, tractors, trailers) or off-road vehicles, such as heavy agricultural vehicles or earthmoving equipment, or other transportation or handling vehicles.

The invention also relates, per se, to any rubber composite (article or semi-finished product), in particular any tyre, before and after curing (for final crosslinking or vulcanization), comprising a textile material according to the invention.

The invention and its advantages will be easily understood in the light of the description and implementational examples which follow.

### I—FORMULATION OF THE AQUEOUS ADHESIVE COMPOSITION

In the present description, unless expressly indicated otherwise, all the percentages (%) shown are % by weight.

“Diene” elastomer (or, without distinction, rubber) is understood to mean an elastomer resulting at least in part (that is to say, a homopolymer or a copolymer) from diene monomer(s) (i.e., monomer(s) bearing two conjugated or non-conjugated carbon-carbon double bonds). “Isoprene elastomer” is understood to mean an isoprene homopolymer or copolymer, in other words a diene elastomer selected from the group consisting of natural rubber (NR), synthetic polyisoprenes (IRs), various isoprene copolymers and the mixtures of these elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The expression “composition based on” should, of course, be understood as meaning a composition comprising the mixture and/or the reaction product of the various base constituents used for this composition (reference is made to pre-condensed phenol/aldehyde resin), it being possible for some of them to be intended to react or capable of reacting with one another or with their immediate chemical surroundings, at least partly, during the various phases of manufacture of the composition, of the textile material or of the composites or finished articles comprising such composites, in particular during a curing stage.

The aqueous adhesive composition according to the invention thus comprises at least, on the one hand, A) a (at least one) phenol/aldehyde resin and, on the other hand, B) a (at least one) unsaturated elastomer latex; this phenol/aldehyde resin is, for its part, based on at least one (that is to say, one or more) aldehyde and at least one (that is to say, one or more) polyphenol, which constituents will be described in detail below.

I.1—Aldehyde

The first essential constituent of the phenol/aldehyde resin is an aldehyde of formula (I):

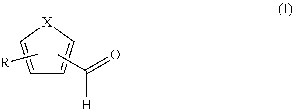

in which X comprises N, S or O and R represents —CHO.

Such aldehydes result from renewable resources and not from oil. The aldehydes result, for example, from biobased sources or from products of the transformation of biobased sources.

Preferably, the aldehyde is of general formula (I′):

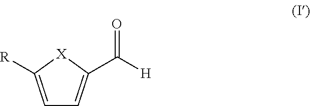

According to a preferred embodiment, X represents O.

In an alternative form of the aldehyde of general formula (I), X represents O and R represents —CHO. The aldehyde used is then of formula (IIb):

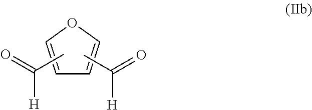

In another alternative form of the aldehyde of general formula (I′), X represents O and R represents —CHO. The aldehyde used is then 2,5-furandicarboxaldehyde and is of formula (II′b):

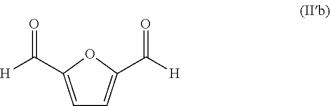

In another embodiment, X comprises N.

In an alternative form of the aldehyde of the general formula (I), X represents NH. The aldehyde used is of formula (IIIa):

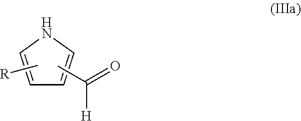

In an alternative form of the aldehyde of general formula (I′), X represents NH. The aldehyde used is of formula (III′a) and is then 2,5-1H-pyrroledicarboxaldehyde:

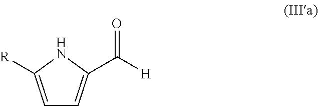

In an another alternative form of the aldehyde of general formula (I), X represents NR1 with R1 representing an alkyl, aryl, arylalkyl, alkylaryl or cycloalkyl group. The aldehyde used is of formula (IIIb):

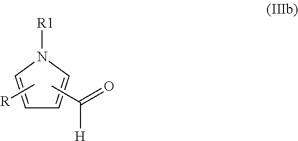

In another embodiment, X comprises S.

In an alternative form of the aldehyde of general formula (I), X represents S. The aldehyde used is of formula (IVa):

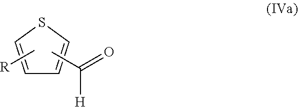

In an alternative form of the aldehyde of general formula (I′), X represents S. The aldehyde used is of formula (IV′a) and is 2,5-thiophenedicarboxaldehyde:

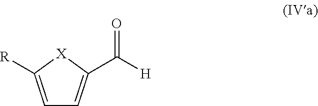

In another alternative form of the aldehyde of general formula (I), X represents SR2 with R2 representing an alkyl, aryl, arylalkyl, alkylaryl or cycloalkyl group. The aldehyde used is of formula (IVb):

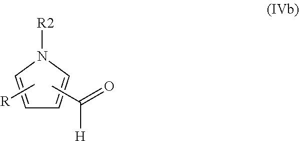

In yet another alternative form of the aldehyde of general formula (I), X represents R3-S—R2 with R2 and R3 each representing, independently of one another, an alkyl, aryl, arylalkyl, alkylaryl or cycloalkyl group. The aldehyde used is of formula (IVc):

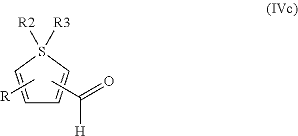

In yet another alternative form of the aldehyde of general formula (I), X represents S═O. The aldehyde used is of formula (IVd):

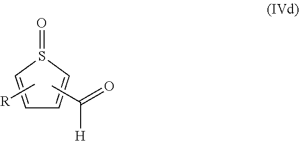

In yet another alternative form of the aldehyde of general formula (I), X represents O═S═O. The aldehyde used is of formula (IVe):

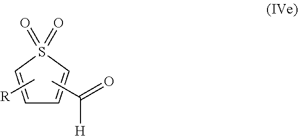

Among the different embodiments described above, preference will be given to the embodiments and the alternative forms in which X represents NH, S or O. In these embodiments and alternative forms, it will be possible to have, in accordance with the invention, R representing —CHO. In these embodiments and alternative forms, R will preferably be in the 5 position and the —CHO group will preferably be in the 2 position on the aromatic nucleus (general formula (I′)).

Preferably, when the phenol/aldehyde resin is based on a single aldehyde of formula (I), the composition is devoid of formaldehyde.

When the phenol/aldehyde resin is based on several aldehydes, at least one of which is of formula (I), each aldehyde is preferably different from formaldehyde. The composition is then also devoid of formaldehyde.

In other words and preferably, the or each aldehyde of the phenol/aldehyde resin is different from formaldehyde.

Devoid of formaldehyde is understood to mean that the content by weight of formaldehyde, by total weight of the aldehyde or aldehydes, is less than or equal to 10%, preferably less than or equal to 5% and more preferably less than or equal to 2%, these percentages corresponding to traces liable to be present in the aldehyde or aldehydes used industrially.

I.2—Polyphenol

The second essential constituent of the phenol/aldehyde resin is a polyphenol comprising one or more aromatic nucleus/nuclei.

In the case of a polyphenol comprising just one aromatic nucleus, the latter bears two or three hydroxyl functional groups in the meta position with respect to each other (in the case of two functional groups) or with respect to one another (in the case of three functional groups), the remainder of the aromatic nucleus being by definition unsubstituted; this is understood to mean that the other carbon atoms of the remainder of the aromatic nucleus (those other than the carbon atoms bearing hydroxyl functional groups) bear a simple hydrogen atom.

Mention may in particular be made, as preferred example of polyphenol comprising just one aromatic nucleus, of resorcinol, as a reminder of expanded formula:

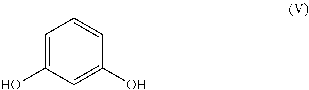

Mention may be made, as even more preferred example comprising just one aromatic nucleus, of phloroglucinol, as a reminder of expanded formula:

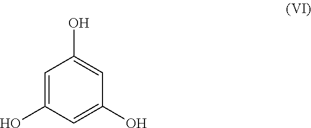

In the case of a polyphenol comprising several (two or more than two) aromatic nuclei, at least two of them each bear two or three hydroxyl functional groups in the meta position with respect to each other (in the case of two functional groups) or with respect to one another (in the case of three functional groups), it being understood that the two positions ortho to at least one of these hydroxyl functional groups are unsubstituted; this is understood to mean that the two carbon atoms located on either side of (in the ortho position to) the hydroxylated carbon atom (i.e., bearing the hydroxyl functional group) bear a simple hydrogen atom.

As preferred examples, in the case where the polyphenol molecule comprises several aromatic nuclei, at least two of these aromatic nuclei, which are identical or different, are selected from those of general formulae:

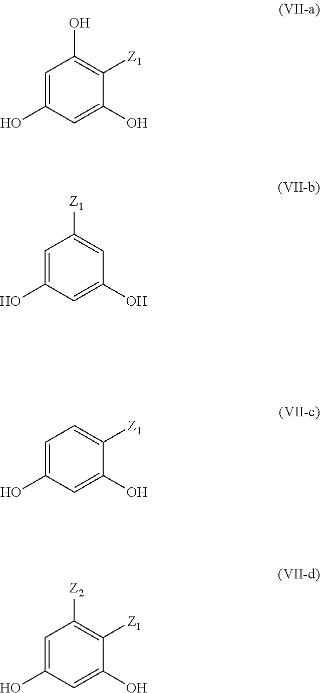

in which the Z₁, Z₂ symbols, which are identical or different, if they are several on the same aromatic nucleus, represent an atom (for example, carbon, sulphur or oxygen) or a connecting group, by definition at least divalent, which connects at least these two aromatic nuclei to the remainder of the polyphenol molecule.

According to a specific and preferred embodiment of the invention, the polyphenol is, for example, a flavonoid, characterized, as a reminder, by a structure based on 15 carbon atoms, formed by two benzene rings connected via three carbon atoms. More particularly, the flavonoid used is 2′,4′,3,5,7-pentahydroxyflavone, also called “morin”, of formula (VIII) below:

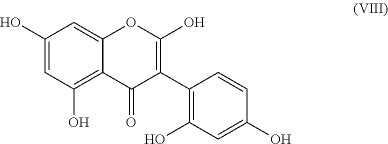 [SMILES: O=c1c(-c2ccc(O)cc2O)c(O)oc2cc(O)cc(O)c12]

It is noted that this compound is a polyphenol comprising two aromatic nuclei (of respective formulae VII-c and VII-d above), each of which indeed bears two hydroxyl functional groups in the meta position with respect to each other, the two positions ortho to at least one of these two hydroxyl functional groups being unsubstituted.

According to another specific and preferred embodiment of the invention, the polyphenol is, for example, phloroglucide, also called 2,4,6,3′,5′-biphenylpentol, of following expanded formula (IX):

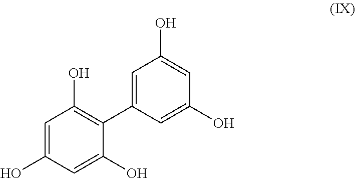 [SMILES: Oc1cc(O)cc(-c2c(O)cc(O)cc2O)c1]

It is noted that this compound is a polyphenol comprising two aromatic nuclei (of respective formulae VII-a and VII-b above), each of which indeed bears at least two (in the case in point, one bears two and the other bears three) hydroxyl functional groups in the meta position with respect to each other, the two positions ortho to at least one of these two hydroxyl functional groups being unsubstituted.

According to yet another specific and preferred embodiment of the invention, the polyphenol is, for example, 2,2′,4,4′-tetrahydroxydiphenyl sulphide of following expanded formula (X):

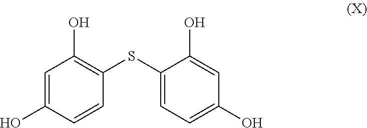 [SMILES: Oc1ccc(Sc2ccc(O)cc2O)c(O)c1]

In a preferred embodiment, the polyphenol is selected from the group consisting of phloroglucinol (VI), 2,2′,4,4′-tetrahydroxydiphenyl sulphide (X) and the mixtures of these compounds.

I.3—Unsaturated Elastomer Latex

It should be remembered that a latex is a stable dispersion of microparticles of elastomer(s) in suspension in an aqueous solution.

Unsaturated (that is to say, bearing carbon-carbon double bonds) elastomer latexes, in particular diene elastomer latexes, are well known to a person skilled in the art. They constitute in particular the elastomeric base of the RFL adhesives described in the introduction to the present account.

In accordance with the invention, the unsaturated elastomer of the latex is preferably a diene elastomer, more preferably a diene elastomer selected from the group consisting of polybutadienes, butadiene copolymers, polyisoprenes, isoprene copolymers and the mixtures of these elastomers. It is more preferably still selected from the group consisting of butadiene copolymers, vinylpyridine/styrene/butadiene terpolymers, natural rubber and the mixtures of these elastomers.

I.4—Additives—Manufacture of the Aqueous Adhesive Composition

The aqueous adhesive composition in accordance with the invention and/or its phenol/aldehyde resin and/or its starting unsaturated elastomer latex can, of course, comprise all or some of the additives normal for aqueous adhesive compositions, such as those used in conventional RFL adhesives; mention will be made, for example, of bases, such as aqueous ammonia, sodium hydroxide, potassium hydroxide or ammonium hydroxide, colourants, fillers, such as carbon black or silica, antioxidants or other stabilizers.

Typically, during a first manufacturing stage, the resin itself is prepared by gradually mixing the polyphenol and the aldehyde in a basic solvent, such as an aqueous sodium hydroxide solution, preferably having a pH of between 9 and 13, more preferably between 10 and 12. The combined constituents are mixed with stirring for a time which can vary according to the temperature used and the specific composition targeted, for example for a period of time which can vary between 1 min and 6 h, at a temperature of between 20° C. and 90° C., preferably between 20° C. and 60° C.

The phenol/aldehyde resin, thus pre-condensed, is generally diluted in water before being added to the unsaturated elastomer latex or latexes (if there are several), in order to form the aqueous adhesive composition of the invention, according to a general procedure which is well-known to a person skilled in the art in the field of RFL adhesives.

For example, the constituents of the adhesive composition are added in the following order: the water, possible water-soluble additives (for example aqueous ammonia), the latex or latexes (order unimportant), the phenol/aldehyde resin (diluted). The combination is mixed with stirring for 1 to 30 min, for example at 20° C.

During a final manufacturing stage, the aqueous adhesive composition is generally stored at ambient temperature (23° C.) for a maturing time which can typically vary from 1 to several hours, indeed even several days, before it is finally used.

Preferably, the ratio by weight of polyphenol to aldehyde is within a range of values extending from 0.1 to 30.

In the final adhesive composition thus prepared, the content of phenol/aldehyde resin as dry matter preferably represents between 5% and 60% by weight, more preferably between 10% and 30% by weight, of the adhesive composition dry matter.

For its part, the content of unsaturated elastomer (that is to say, the dry matter of the latex or latexes) is preferably between 40% and 95% by weight, more preferably between 70% and 90% by weight, of the dry matter of the adhesive composition.

The ratio by weight of the resin dry matter to the latex dry matter is preferably between 0.1 and 2.0, more preferably between 0.15 and 1.0.

The water content of the aqueous adhesive composition of the invention is preferably between 60% and 90%, more preferably between 60% and 85%.

II—TEXTILE MATERIAL AND COMPOSITE OF THE INVENTION

As indicated above, the present invention also relates to the use of the aqueous adhesive composition described above for the adhesive bonding of any textile material to an unsaturated rubber composition, for formation of a reinforced rubber composite of such a material, and also, as such, to the textile material, at least a portion of which is coated with an adhesive composition according to the invention.

II.1—Definitions; Examples of Textile Materials

In the present patent application, by definition, “textile” or “textile material” is understood to mean, in a way well known to a person skilled in the art, any material made of a substance other than a metallic substance, whether natural or synthetic, which is capable of being transformed into thread, fibre or film by any appropriate transformation process. Mention may be made, for example, without the examples below being limiting, of a polymer spinning process, such as, for example, melt spinning, solution spinning or gel spinning.

This textile material can consist of a thread or fibre, a ribbon or film, or also of a fabric produced from threads or fibres, for example a woven fabric with warp threads and weft threads, or else a twill fabric with cross threads.

Preferably, this textile material of the invention is selected from the group consisting of films, monofilaments (or individual threads), multifilament fibres, assemblies of such threads or fibres, and mixtures of such materials. It is more particularly a monofilament, a multifilament fibre or a folded yarn.

The term “thread” or “fibre” is generally understood to mean any elongate element of great length relative to its cross section, whatever the shape, for example circular, oblong, rectangular, square, or even flat, of this cross section, it being possible for this thread to be straight or not straight, for example twisted or wavy. The largest dimension of its cross section is preferably less than 5 mm, more preferably less than 3 mm.

This thread or fibre may take any known form. For example, it may be an individual monofilament of large diameter (for example and preferably equal to or greater than 50 μm), a multifilament fibre (consisting of a plurality of individual filaments of small diameter, typically less than 30 μm), a textile folded yarn or cord formed from several textile fibres or monofilaments twisted or cabled together, or else an assembly, group or row of threads or fibres, such as, for example, a band or strip comprising several of these monofilaments, fibres, folded yarns or cords grouped together, for example aligned along a main direction, whether straight or not.

The term “film” or “ribbon” is generally understood to mean an elongate element of great length relative to its cross section, the cross section of which has an aspect ratio (width to thickness) of greater than 5, preferably of greater than 10, and the width of which is preferably at least equal to 3 mm, more preferably at least equal to 5 mm.

The aqueous adhesive composition of the invention can be applied to any textile material as described above and capable of reinforcing rubber articles, such as tyres, including textile materials made of organic or polymeric substance, such as made of inorganic substance.

Mention will be made, as examples of inorganic substances, of glass or carbon.

The invention is preferably implemented with polymeric substances, of the thermoplastic or non-thermoplastic type, and the assemblies of these substances.

Mention will be made, as examples of polymeric substances of the non-thermoplastic type, of aromatic polyamides, for example aramid, and cellulose, both natural and artificial, such as cotton, rayon, flax or hemp.

Mention will preferably be made, as examples of polymeric substances of the thermoplastic type, of aliphatic polyamides and of polyesters. Mention may in particular be made, among the aliphatic polyamides, of the polyamides PA-4,6, PA-6, PA-6,6 (nylon), PA-11 or PA-12. Mention may be made, among the polyesters, for example, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate).

II.2—Manufacture of the Textile Material and of the Composite

The textile material of the invention can be prepared according to a sizing process comprising at least one stage of deposition, on an (initial) textile material, of an adhesive composition in accordance with the invention.

The stage of deposition of the adhesive composition on the initial textile material (starting textile material) can be carried out according to any appropriate method, in particular by any known coating technique, such as, for example, spraying, impregnation by dipping, forward progression in a bath or other equivalent technique for the deposition of a thin or ultra-thin film of adhesive, or also by a combination of one or more of these techniques.

The weight of dry matter of the aqueous adhesive composition deposited on one kilogram of textile material is preferably between 5 and 100 g, more preferably between 30 and 70 g and more preferably still between 40 and 60 g.

The invention also applies to the cases where the starting textile material has been precoated with an adhesion primer, such as those commonly used by a person skilled in the art for the pre-sizing of certain textile fibres (fibres made of polyester, for example PET, of aramid or of aramid/nylon). The fibres, thus precoated, are then subjected to a subsequent and definitive sizing with the aqueous adhesive composition according to the invention.

After the stage, described above, of deposition of the adhesive composition, the sized material is subjected to a first heat treatment, targeted at removing any solvent or water, at a temperature of preferably between 110° C. and 260° C., more preferably between 130° C. and 250° C., for example by passing through a tunnel oven, typically with a length of several metres, such as those commonly used for the heat treatment after sizing of the textile materials with an RFL adhesive.

The invention also relates to the textile material obtained after drying, that is to say, after a heat treatment targeted at removing the water from the textile material according to the invention, at least a portion of which is coated with an adhesive layer comprising an adhesive composition according to the invention.

The anhydrous material thus obtained is then subjected to a second heat treatment in order to terminate the crosslinking of the adhesive composition, preferably carried out in air in a tunnel oven as described above. The treatment temperature is preferably between 150° C. and 350° C. The treatment times are from a few seconds to a few minutes, according to the circumstances (for example, between 10 s and 10 min).

Where appropriate, a person skilled in the art will know how to adjust the temperature and the duration of the heat treatment above according to the particular operating conditions of the invention, especially according to the exact nature of the textile material manufactured, in particular depending on whether the treatment is on monofilaments, multifilament fibres, folded yarns consisting of several fibres twisted together, or films. In particular, a person skilled in the art will have the advantage of varying the treatment temperature and treatment time so as to find, by successive approximations, the operating conditions giving the best adhesion results for each particular embodiment of the invention.

Thus sized, the textile material of the invention is preferably intended to adhere to an unsaturated rubber composition, such as a diene rubber, in order to form a reinforced rubber composite which constitutes another subject-matter of the invention.

This rubber composite can be prepared according to a process comprising at least the following stages:
during a first stage, combining at least a portion of the textile material according to the invention with an unsaturated (crosslinkable) rubber composition, in order to form a rubber composite reinforced with the textile material;
then, during a second stage, crosslinking the composite thus formed by curing, preferably under pressure.

The invention thus applies to any type of rubber composite capable of being obtained by the process described above, comprising at least a matrix made of crosslinkable rubber composition, in particular diene rubber composition, bonded to the textile material via an adhesive interphase based on the adhesive composition according to the invention.

The diene elastomer of the composite is preferably selected from the group consisting of polybutadienes (BRs), natural rubber (NR), synthetic polyisoprenes (IRs), butadiene/styrene copolymers (SBRs), isoprene/butadiene copolymers (BIRs), isoprene/styrene copolymers (SIRs), butadiene/styrene/isoprene copolymers (SBIRs) and the mixtures of these elastomers. A preferred embodiment consists in using an “isoprene” elastomer, that is to say an isoprene homopolymer or copolymer, in other words a diene elastomer selected from the group consisting of natural rubber (NR), synthetic polyisoprenes (IRs), the various copolymers of isoprene and the mixtures of these elastomers. The isoprene elastomer is preferably natural rubber or a synthetic polyisoprene of the cis-1,4 type.

II.3—Application on Tyres

The textile material of the invention can advantageously be used to reinforce tyres for all types of vehicles, in particular passenger vehicles or industrial vehicles, such as heavy-duty vehicles.

By way of example, the single appended figure represents very diagrammatically (without observing a specific scale) a radial section of a tyre in accordance with the invention for a vehicle of the passenger type.

This tyre 1 comprises a crown 2 reinforced by a crown reinforcement or belt 6, two sidewalls 3 and two beads 4, each of these beads 4 being reinforced with a bead thread 5. The crown 2 is surmounted by a tread, not represented in this diagrammatic figure. A carcass reinforcement 7 is wound around the two bead threads 5 in each bead 4, the turn-up 8 of this reinforcement 7 being, for example, positioned towards the outside of the tyre 1, which is here represented fitted onto its wheel rim 9. The carcass reinforcement 7 is, in a way known per se, composed of at least one ply reinforced by “radial” cords, for example textile cords, that is to say that these cords are positioned virtually parallel to one another and extend from one bead to the other so as to form an angle of between 80° and 90° with the median circumferential plane (plane perpendicular to the axis of rotation of the tyre which is located halfway between the two beads 4 and passes through the middle of the crown reinforcement 6).

This tyre 1 of the invention has, for example, the essential characteristic that at least a crown reinforcement 6 and/or its carcass reinforcement 7 comprises a textile material according to the invention. According to another possible implementational example of the invention, it is, for example, the bead threads 5 which might be composed, in all or in part, of a textile material according to the invention.

Of course, the invention relates to the objects described above, namely the textile material and the rubber composite, such as tyre, comprising it, both in the raw state (before curing or vulcanization) and in the cured state (after curing).

### III—EXAMPLES OF THE IMPLEMENTATION OF THE INVENTION AND COMPARATIVE TESTS

These tests demonstrate that the adhesion, to a diene elastomer composition, of textile cords sized with an aqueous adhesive composition according to the invention is equivalent in comparison with cords sized with a conventional adhesive composition of the RFL type.

For this, several aqueous adhesive compositions were prepared as indicated above, several in accordance with the invention (hereinafter denoted C-1.5 to C-1.8) and several controls (control compositions, hereinafter denoted C-1.1 to C-1.4). Their formulations (expressed as percentage by weight) are presented in the appended Table 1. The amounts listed in this table are those of the constituents in the dry state, with respect to a total of 100 parts by weight of aqueous adhesive composition (that is to say, the constituents plus the water).

The adhesive composition C-1.1 is a control composition, of RFL type, commonly used for the adhesion of textile cords to a rubber composition. This adhesive composition is based on resorcinol and formaldehyde.

The adhesive composition C-1.2 is a control composition based on furfuraldehyde and a resorcinol/formaldehyde pre-condensed resin.

The adhesive composition C-1.3 is a control composition based on furfuraldehyde and phloroglucinol.

The adhesive composition C-1.4 is a control composition based on formaldehyde and phloroglucinol.

Each aqueous adhesive composition C-1.5 to C-1.8 comprises a phenol/aldehyde resin based on one or more aldehydes, the or each aldehyde being different from formaldehyde. In the case in point, each phenol/aldehyde resin is based on a single aldehyde of formula (I). In an alternative form, each phenol/aldehyde resin can be based on several aldehydes and/or on several phenols. The aqueous adhesive composition C-1.5 according to the invention is based on phloroglucinol and 2,5-furandicarboxaldehyde. The aqueous adhesive composition C-1.6 according to the invention is based on resorcinol and 2,5-furandicarboxaldehyde. The aqueous adhesive composition C-1.7 according to the invention is based on 2,2′,4,4′-tetrahydroxydiphenyl sulphide (resorcinol sulphide) and 2,5-furandicarboxaldehyde. The aqueous adhesive composition C-1.8 according to the invention is based on phloroglucinol and 2,5-thiophenedicarboxaldehyde. Thus, each aqueous adhesive composition C-1.5 to C-1.8 is substantially devoid of formaldehyde.

Each adhesive composition C-1.1 to C-1.8 exhibits a ratio by weight of polyphenol to aldehyde within a range of values of between 0.1 and 30.

These adhesive compositions C-1.1 to C-1.8 are furthermore all based on natural rubber (NR) latex, styrene-butadiene copolymer (SBR) latex and vinylpyridine/styrene/butadiene (VPSBR) latex.

The quality of the bonding between the rubber composition and the textile material is determined by a test in which the force necessary to extract sections of cords made of textile material from the vulcanized rubber composition is measured. This rubber composition is a conventional composition which can be used for the calendering of tyre carcass reinforcement textile plies, based on natural rubber, carbon black and standard additives.

More specifically, the vulcanizate is a rubber block consisting of two sheets measuring 200 mm by 4.5 mm and with a thickness of 3.5 mm, applied against each other before curing (the thickness of the resulting block is then 7 mm). It is during the production of this block that the textile cords (15 sections in total) are imprisoned between the two rubber sheets in the raw state, an equal distance apart and while allowing a cord end to project out on either side of these sheets with a length sufficient for the subsequent tensile testing. The block comprising the cords is then placed in a suitable mould and then cured under pressure. The curing temperature and the curing time are adapted to the intended test conditions and left to the discretion of a person skilled in the art; by way of example, in the present case, the block is cured at 160° C. for 15 min.

On conclusion of the curing, the test specimen, thus consisting of the vulcanized block and the 15 sections of cords, is placed between the jaws of a suitable tensile testing machine in order to make it possible to test each section individually, at a given rate and a given temperature (for example, in the present case, at 100 mm/min and 20° C.).

The adhesion levels are characterized by measuring the “tearing-out” force (denoted by Fₘₐₓ) for tearing the reinforcers out of the test specimen. A value greater than that for the control test specimen, arbitrarily set at 100, indicates an improved result, that is to say, a greater tearing-out force than that for the control test specimen. The results of the tests carried out on the test specimens are summarized in Table 1. The comment NT means that the measurement was not carried out.

III.1—Test 1: Adhesion of Nylon Textile Cords

In the case of Nylon (aliphatic polyamide-6,6) cords, it is known to precoat them in a first bath generally based on epoxy in aqueous solution, for example based on polyglycerol polyglycidyl ether. The ingredients are introduced into the water with stirring, for example in the following order: 0.5 per cent by weight of polyglycerol polyglycidyl ether (for example “Denacol EX-512” from Nagase Chemicals), 0.03 per cent by weight of surfactant (dioctyl sodium sulphosuccinate, sold under the name “AOT 75”) and 0.03 per cent by weight of sodium hydroxide, 99.44 per cent by weight of water.

The Nylon cords of these examples consist of folded yarns comprising two strands of 140×2 (count of each strand equal to 140 tex) and 250/250 (twist in t/m) construction; thus precoated, they are subsequently sized with aqueous adhesive compositions according to the invention and a control composition, and then dried in a drying oven at 180° C. for 30 s. The adhesive composition was then crosslinked by passing the textile cords through a treatment oven at 230° C. for 30 s. The assembly was then rendered integral, by curing, with a natural rubber composition by virtue of a vulcanization heat treatment, in order to form composite test specimens as described above.

III.2—Test 2: Adhesion of PET Textile Cords

In the case of PET textile cords, it is known to precoat them in a way analogous to that used for the Nylon textile cords.

The PET textile cords of these examples consist of folded yarns comprising two strands of 144×2 (count of each PET strand equal to 144 tex) and 420/420 (twist in t/m) construction; thus precoated, they are subsequently sized in a way analogous to that used for the Nylon textile cords. They were then rendered integral, by curing, with a natural rubber composition, as above for the Nylon textile cords, by virtue of a vulcanization heat treatment, in order to form composite test specimens.

It is found that the textile cords sized with the adhesive compositions C-1.4, C-1.5, C-1.6 and C-1.8 according to the invention exhibit a tearing-out force Fₘₐₓ equivalent (±10% with respect to the control composition C-1.1) to that of the control cord sized with the composition C-1.1 (arbitrarily set at 100). Even if it is lower than that of the control cord sized with the composition C-1.1, the tearing-out force Fₘₐₓ of the textile cords sized with the adhesive composition C-1.7 makes it possible, however, to obtain a significant tearing-out force sufficient for a person skilled in the art. This is because these results are entirely acceptable in ensuring sufficient adhesive bonding of textile cords to a diene elastomer composition.

It is often noted that the compositions C-1.5 to C-1.8 according to the invention exhibit a much greater tearing-out force Fₘₐₓ than that of the compositions C-1.2 to C-1.3 using an aromatic monoaldehyde which, a priori, would exhibit a greater reactivity than that of aromatic polyaldehydes.

It is also noted that the compositions C-1.5 and C-1.8 according to the invention comprising phloroglucinol are those exhibiting the highest tearing-out forces Fₘₐₓ.

In conclusion, the results of these different tests clearly demonstrate that the adhesive compositions according to the invention constitute an advantageous strong alternative to the use of conventional RFL adhesives in which the formaldehyde, in contrast to the aldehydes of the adhesive compositions of the invention, results from oil.

TABLE 1

| | Adhesive compositions | | | | | | | |
|---|---|---|---|---|---|---|---|---|
| | C-1.1 | C-1.2 | C-1.3 | C-1.4 | C-1.5 | C-1.6 | C-1.7 | C-1.8 |
| Aldehyde | | | | | | | | |
| Formaldehyde (1) | 0.9 | — | — | 0.9 | — | — | — | — |
| 2,5-Furandicarboxaldehyde (2) | — | — | — | — | 0.9 | 0.9 | 0.9 | — |
| Furfuraldehyde (3) | — | 0.5 | 0.9 | — | — | — | — | — |
| 2,5- | — | — | — | — | — | — | — | 0.9 |
| Thiophenedicarboxaldehyde (4) | | | | | | | | |
| Polyphenol | | | | | | | | |
| Resorcinol (5) | 1.7 | — | — | — | — | 1.7 | — | — |
| Phloroglucinol (6) | — | — | 1.7 | 1.7 | 1.7 | — | — | 1.7 |
| 2,2′,4,4′- | — | — | — | — | — | — | 1.7 | — |
| Tetrahydroxydiphenyl | | | | | | | | |
| sulphide (7) | | | | | | | | |
| SRF 1524 (8) | — | 2.1 | — | — | — | — | — | — |
| Sodium hydroxide (9) | 0.2 | 0.2 | 0.2 | 0.2 | 0.2 | 0.2 | 0.2 | 0.2 |
| Elastomer latex | | | | | | | | |
| NR (10) | 6.4 | 6.4 | 6.4 | 6.4 | 6.4 | 6.4 | 6.4 | 6.4 |
| SBR (11) | 3.2 | 3.2 | 3.2 | 3.2 | 3.2 | 3.2 | 3.2 | 3.2 |
| VP-SBR (12) | 6.4 | 6.4 | 6.4 | 6.4 | 6.4 | 6.4 | 6.4 | 6.4 |
| Aqueous ammonia (13) | 0.5 | 0.5 | 0.5 | 0.5 | 0.5 | 0.5 | 0.5 | 0.5 |
| Total weight of dry matter | 19.3 | 19.3 | 19.3 | 19.3 | 19.3 | 19.3 | 19.3 | 19.3 |
| of adhesive composition | | | | | | | | |
| Weight of water | 80.7 | 80.7 | 80.7 | 80.7 | 80.7 | 80.7 | 80.7 | 80.7 |
| Adhesion tests | | | | | | | | |
| Fₘₐₓ at 20° C. (Nylon) | 100 | 69 | 78 | NT | NT | NT | NT | NT |
| Fₘₐₓ at 20° C. (PET) | 100 | 78 | 87 | 99 | 93 | 93 | 78 | 98 |

(1) Formaldehyde (from Caldic; diluted to 36%);
(2) 2,5-Furandicarboxaldehyde (from Aldrich; purity of 97%);
(3) Furfuraldehyde (from Aldrich; purity of 99%);
(4) 2,5-Thiophenedicarboxaldehyde (from Aldrich; purity of 98%);
(5) Resorcinol (from Sumitomo; purity of 99.5%);
(6) Phloroglucinol (from Alfa Aesar; purity of 99%);
(7) 2,2′,4,4′-Tetrahydroxydiphenyl sulphide (from Alfa Aesar; purity of 98%);
(8) Pre-condensed resin SRF 1524 (from Schenectady; diluted to 75%);
(9) Sodium hydroxide (from Aldrich; diluted to 30%);
(10) NR Latex (“Trang Latex” from Bee tex; diluted to 61% by weight);
(11) SBR Latex (“Encord-201” from Jubilant; diluted to 41% by weight);
(12) Vinylpyridine/styrene/butadiene latex (“VP 106S” from Eliokem; diluted to 41%);
(13) Aqueous ammonia (from Aldrich; diluted to 21%).

1.-13. (canceled)

14. An aqueous adhesive composition comprising:
(a) a phenol/aldehyde resin; and
(b) an unsaturated elastomer latex,
wherein the phenol/aldehyde resin comprises:
(A1) an aldehyde of formula (I): 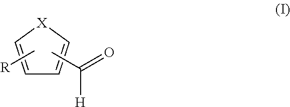
in which X is selected from the group consisting of N, S and O, and R represents —CHO; and
(A2) a polyphenol comprising one or more aromatic nucleus/nuclei,
wherein, when the polyphenol comprises only one aromatic nucleus, the aromatic nucleus bears two or three hydroxyl functional groups in the meta position with respect to each other, and the remainder of the aromatic nucleus is unsubstituted; and
wherein, when the polyphenol comprises more than one aromatic nuclei, at least two aromatic nuclei each bear two or three hydroxyl functional groups in the meta position with respect to each other, and the two positions ortho to at least one of the two or three hydroxyl functional groups are unsubstituted.

15. The composition according to claim 14, wherein the aldehyde is of general formula (I′):

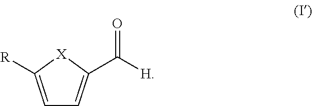

16. The composition according to claim 14, wherein the aldehyde is 2,5-furandicarboxaldehyde.

17. The composition according to claim 14, wherein the polyphenol is selected from the group consisting of phloroglucinol, 2,2′,4,4′-tetrahydroxydiphenyl sulphide and mixtures thereof.

18. The composition according to claim 14, wherein the unsaturated elastomer latex comprises a diene elastomer.

19. The composition according to claim 18, wherein the diene elastomer is selected from the group consisting of polybutadienes, butadiene copolymers, polyisoprenes, isoprene copolymers, vinylpyridine/styrene/butadiene terpolymers and mixtures thereof.

20. The composition according to claim 14, wherein a ratio by weight of polyphenol to aldehyde is within a range of values extending from 0.1 to 30.

21. A textile material comprising at least a portion coated with an adhesive layer comprising an adhesive composition according to claim 14.

22. The textile material according to claim 21,wherein the textile material comprises a material selected from the group consisting of thermoplastic polymers, non-thermoplastic polymers and assemblies of thermoplastic polymers and non-thermoplastic polymers.

23. A process for the manufacture of a textile material comprising the step of:
depositing an adhesive composition according to claim 14.

24. A process for adhesively bonding a textile material to an unsaturated rubber comprising the step of:
bonding the textile material and the unsaturated rubber with an adhesive composition according to claim 14.

25. A rubber composite reinforced with a textile material according to claim 21.

26. A tire comprising a rubber composite according to claim 25.
